(19) United States
(12) Patent Application Publication
(10) Pub. No.: US 2018/0064245 A1
(43) Pub. Date: Mar. 8, 2018

(54) PANEL FASTENER AND PANEL

(71) Applicant: YI-HSING HUANG, NEW TAIPEI CITY (TW)

(72) Inventor: YI-HSING HUANG, NEW TAIPEI CITY (TW)

(21) Appl. No.: 15/694,360

(22) Filed: Sep. 1, 2017

(30) Foreign Application Priority Data
Sep. 6, 2016 (TW) 105128709

(51) Int. Cl. A47B 47/00; F16B 5/06; F16B 12/44

(52) U.S. Cl. CPC A47B 47/0033; F16B 5/0614; F16B 2005/0678; F16B 12/44; A47B 47/0016; F16B 5/0607

(57) ABSTRACT

A panel fastener for use with a plurality of panels to build a DIY cabinet is introduced. The panel fastener comprises a first side, a second side and a third side. The first side has a first notch. The second side has a cruciform notch formed from a first notch and a second notch. The third side has a cruciform notch formed from a first notch and a second notch, with the first and second notches each being of a width sufficient to admit at least one panel.

### CROSS-REFERENCE TO RELATED APPLICATION

This non-provisional application claims priority under 35 U.S.C. §119(a) on Patent Application No(s). 105128709 filed in Taiwan, R.O.C. on Sep. 6, 2016, the entire contents of which are hereby incorporated by reference.

### FIELD OF THE INVENTION

The present invention relates to panel fasteners and panels and, more particularly, to a universal panel fastener and a panel engaged therewith.

### BACKGROUND OF THE INVENTION

A typical conventional DIY cabinet consists of panel fasteners and panels engaged with the panel fasteners. Easy to use and variable in shape to meet user needs, the DIY cabinet is convenient in terms of assembly, use and disassembly.

The conventional DIY cabinet requires different types of panel fasteners, including a panel fastener with a cruciform notch, and another panel fastener with a linear notch, to work in respective ways. For instance, panels put together by the panel fastener with the cruciform notch collectively assume a cruciform shape to define four separate storage spaces, whereas the panel fastener with the linear notch connects two panels in series to form a larger single panel. The aforesaid diversity of the conventional panel fasteners however brings the aforesaid advantages of the conventional DIY cabinet not only to the detriment of universality of the panel fasteners, but also at the expense of consumers' cost control and time efficiency in assembly and disassembly.

Accordingly, it is imperative to provide a panel fastener which overcomes the aforesaid drawbacks of the prior art.

### SUMMARY OF THE INVENTION

It is an objective of the present invention to provide a universal panel fastener applicable to different combinations of panels.

Another objective of the present invention is to provide a panel engaged with the panel fastener. In order to achieve the above and other objectives, the present invention provides a panel fastener for use with a plurality of panels to build a DIY cabinet, the panel fastener comprising: a first side with a first notch; a second side with a cruciform notch formed from a first notch and a second notch; and a third side with a cruciform notch formed from a first notch and a second notch, wherein the first notch of the first side is of a width sufficient to admit two panels, the first notch of the second side to admit one panel, the second notch of the second side to admit one panel, the first notch of the third side to admit two panels, and the second notch of the third side to admit one panel.

In an embodiment of the present invention, the first notch of the first side is of a width sufficient to admit two panels.

In an embodiment of the present invention, the first notch and second notch of the second side are each of a width sufficient to admit one panel.

In an embodiment of the present invention, the first notch of the third side is of a width sufficient to admit two panels and the second notch of the third side to admit one panel.

In an embodiment of the present invention, a press bump is disposed at a junction of the first notch of the second side and the second notch of the second side, and a press bump is disposed at a junction of the first notch of the third side and the second notch of the third side.

In an embodiment of the present invention, the panel fastener further comprises a fourth side with a cruciform notch, the cruciform notch being formed from a first notch and a second notch, the first and second notches each being of a width sufficient to admit at least one panel.

In an embodiment of the present invention, the second notch of the fourth side is formed from a third notch and a fourth notch, whereas the first notch of the fourth side is of a width sufficient to admit two panels, the third notch of the fourth side to admit one panel, and the fourth notch of the fourth side to admit two panels.

In an embodiment of the present invention, an engaging flange is disposed at edges of the first, second, third and fourth notches.

In an embodiment of the present invention, an engaging flange is disposed at two edges of the first notch of the first side.

In order to achieve the above and other objectives, the present invention further provides a panel engaged with the panel fastener to build a DIY cabinet.

In an embodiment of the present invention, the panel further comprises at least a joint hole which the first notch of the first side of the panel fastener is unfastenably engaged with.

In an embodiment of the present invention, an engaging groove is disposed at an edge of the at least a joint hole and engaged with the engaging flanges of the first, second, third and fourth notches.

Therefore, the present invention provides a panel fastener whose outer sides have notches which come in various shapes so that panels can be put together in different ways by the panel fastener, thereby rendering it easy for a user to assemble a DIY cabinet.

### BRIEF DESCRIPTION OF THE DRAWINGS

FIG. 1A through FIG. 1C are perspective views of a panel fastener from different angles according to the first embodiment of the present invention;

FIG. 2A is a schematic view of how to fasten panels to a first side of the panel fastener according to the first embodiment of the present invention;

FIG. 2B is a schematic view of how to fasten panels to a second side of the panel fastener according to the first embodiment of the present invention;

FIG. 2C is a schematic view of how to fasten panels to a third side of the panel fastener according to the first embodiment of the present invention;

FIG. 3 is a perspective view of the panel fastener according to the second embodiment of the present invention;

FIG. 4 is a schematic view of how to fasten panels to a fourth side of the panel fastener according to the second embodiment of the present invention;

FIG. 5A and FIG. 5B are an exploded view and a schematic view of how to fasten panels to the panel fastener according to the second embodiment of the present invention, respectively; and

FIG. 6 is a schematic view of a DIY cabinet which consists of panels fastened to the panel fastener according to the second embodiment of the present invention.

### DETAILED DESCRIPTION OF THE PREFERRED EMBODIMENTS

Objectives, features, and advantages of the present invention are hereunder illustrated with specific embodiments in conjunction with the accompanying drawings.

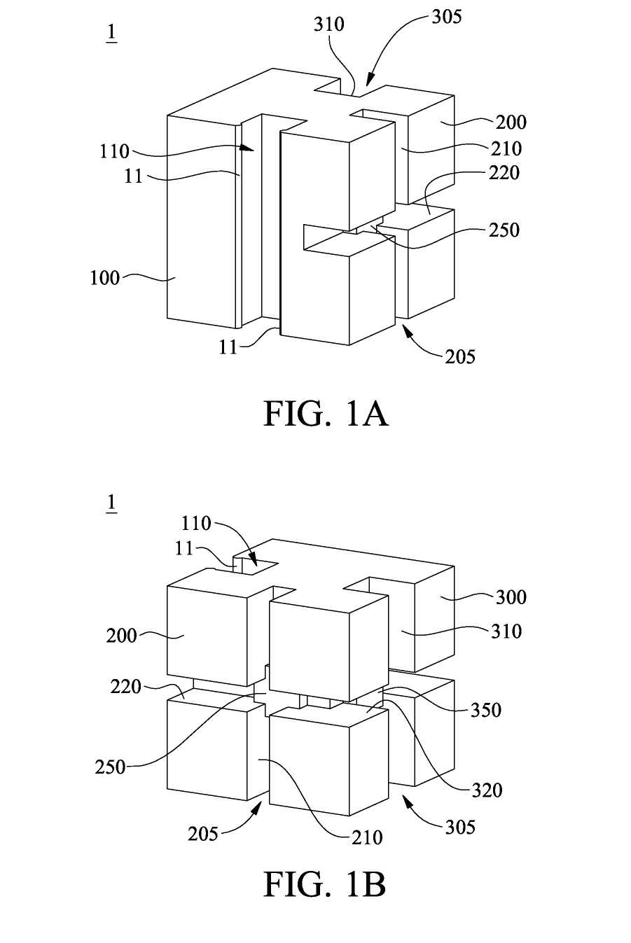

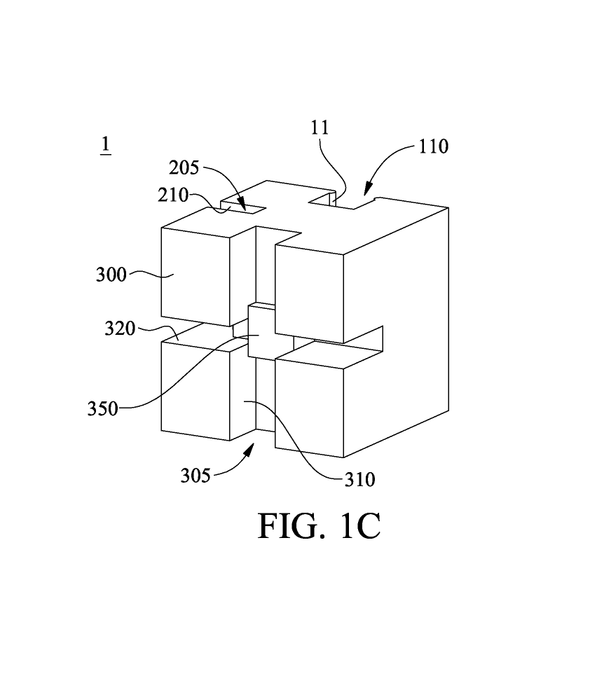

Referring to FIG. 1A through FIG. 1C, there are shown perspective views of a panel fastener 1 from different angles according to the first embodiment of the present invention. The panel fastener 1 is for use with a plurality of panels (not shown). The panels are put together by the panel fastener 1 to build a DIY cabinet and meet user needs or design requirements. The panel fastener 1 comprises a first side 100, a second side 200 and a third side 300. In this embodiment, the panel fastener 1 is a cube.

Referring to FIG. 1A, the first side 100 has a first notch 110. In this embodiment, the first notch 110 of the first side 100 is of a width sufficient to admit two superimposed panels (not shown), because the width of the first notch 110 of the first side 100 is two times larger than the thickness of each panel. In a variant embodiment of the present invention, the width of the first notch 110 of the first side 100 equals a multiple of the thickness of each panel. An engaging flange 11 is disposed at the edge of the first notch 110 of the first side 100 and engaged with the panels.

Referring to FIG. 1B, the second side 200 has a cruciform notch 205. In this embodiment, the cruciform notch 205 of the second side 200 is formed from a first notch 210 and a second notch 220, whereas the first notch 210 and the second notch 220 are each of a width sufficient to admit only one panel (not shown), because the width of the first notch 210 of the second side 200 and the width of the second notch 220 of the second side 200 each equal the thickness of each panel. In a variant embodiment, the width of the first notch 210 of the second side 200 and the width of the second notch 220 of the second side 200 each equal a multiple of the thickness of each panel.

A press bump 250 is disposed at the junction of the first notch 210 of the second side 200 and the second notch 220 of the second side 200 and adapted to press against the panels admitted into the first notch 210 of the second side 200 and the second notch 220 of the second side 200, so as to prevent the panels from undergoing any displacement under any external force.

Referring to FIG. 1C, the third side 300 has a cruciform notch 305. In this embodiment, the cruciform notch 305 of the third side 300 is formed from a first notch 310 and a second notch 320. The first notch 310 of the third side 300 is of a width sufficient to admit two superimposed panels (not shown), whereas the second notch 320 of the third side 300 is of a width sufficient to admit one panel (not shown), because the width of the first notch 310 of the third side 300 is two times larger than the thickness of each panel, and the width of the second notch 320 of the third side 300 equals the thickness of each panel. In a variant embodiment, the widths of the first notch 310 of the third side 300 and the second notch 320 of the third side 300 each equal a multiple of the thickness of each panel.

A press bump 350 is disposed at the junction of the first notch 310 of the third side 300 and the second notch 320 of the third side 300 and adapted to press against the panels admitted into the first notch 310 of the third side 300 and the second notch 320 of the third side 300, so as to prevent the panels from undergoing any displacement under any external force.

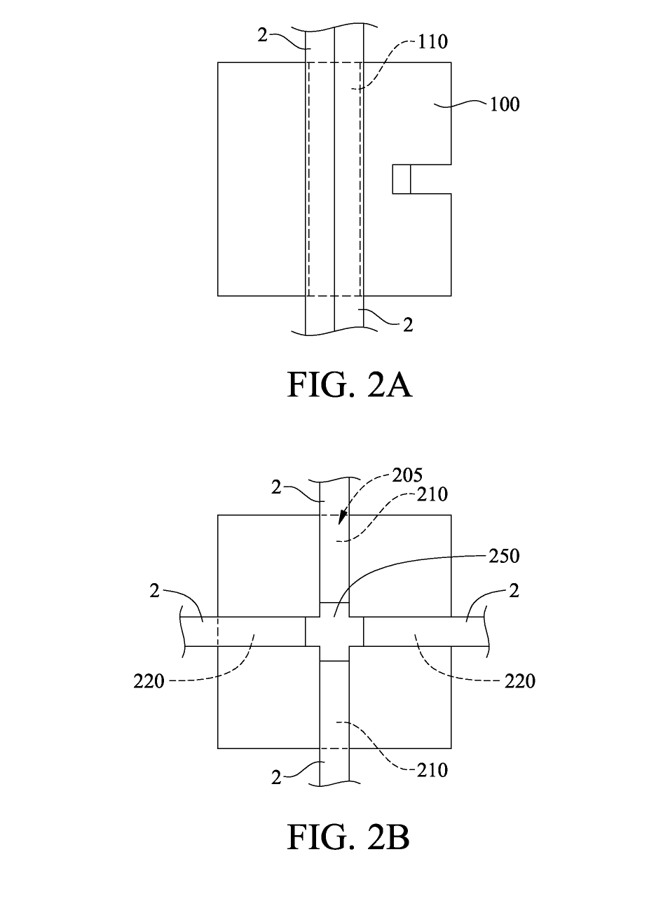

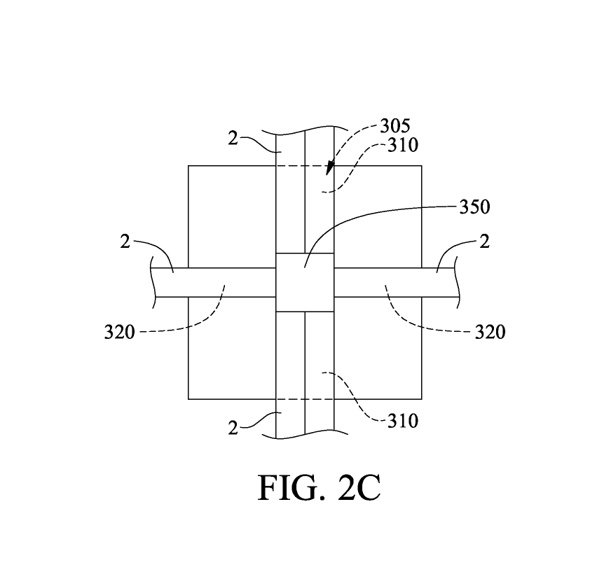

Referring to FIG. 2A through FIG. 2C, there are shown schematic views of how to fasten panels to the first side 100, the second side 200 and the third side 300 of the panel fastener 1 according to the first embodiment of the present invention, respectively.

Referring to FIG. 2A, the first notch 110 of the first side 100 is of a width sufficient to admit two superimposed panels 2.

Referring to FIG. 2B, the first notch 210 and the second notch 220 of the second side 200 are each of a width sufficient to admit one panel 2. The panel 2 is pressed against the press bump 250 and thereby prevented from undergoing any displacement under any external force.

Referring to FIG. 2C, the first notch 310 of the third side 300 is of a width sufficient to admit two superimposed panels 2, whereas the second notch 320 of the third side 300 is of a width sufficient to admit one panel 2. The panel 2 is pressed against the press bump 350 and thereby prevented from undergoing any displacement under any external force.

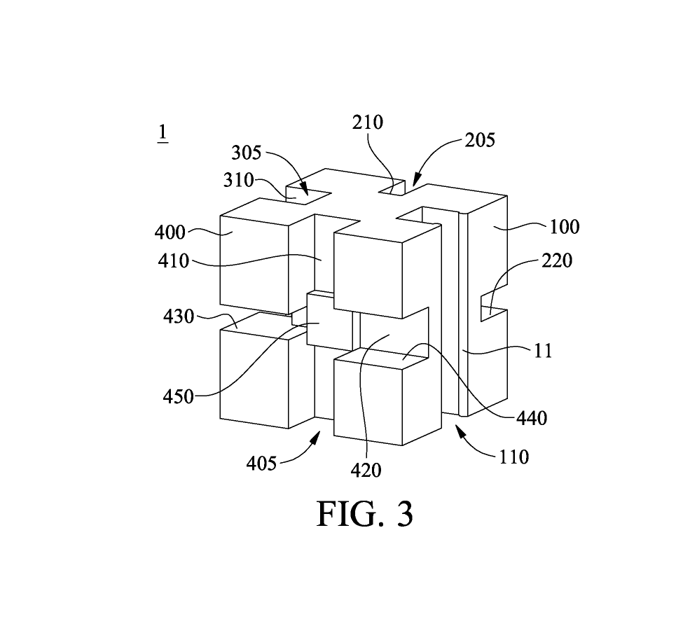

Referring to FIG. 3, there is shown a perspective view of the panel fastener 1 according to the second embodiment of the present invention. The panel fastener 1 further comprises a fourth side 400. The fourth side 400 has a cruciform notch 405. In this embodiment, the cruciform notch 405 of the fourth side 400 is formed from a first notch 410 and a second notch 420. The second notch 420 of the fourth side 400 is formed from a third notch 430 and a fourth notch 440. The first notch 410 of the fourth side 400 is of a width sufficient to admit two superimposed panels (not shown). The third notch 430 of the fourth side 400 is of a width sufficient to admit one panel (not shown). The fourth notch 440 of the fourth side 400 is of a width sufficient to admit two superimposed panels (not shown). It is because the first notch 410 and the fourth notch 440 are each of a width two times larger than the thickness of each panel, whereas the third notch 430 is of a width equal to the thickness of each panel. In a variant embodiment, the first notch 410, the third notch 430 and the fourth notch 440 of the fourth side 400 are each of a width equal to a multiple of the thickness of each panel.

A press bump 450 is disposed at the junction of the first notch 410, the third notch 430 and the fourth notch 440 of the fourth side 400. Therefore, the panels admitted into the first notch 410, the third notch 430 and the fourth notch 440 of the fourth side 400 are pressed against the press bump 450 and thereby prevented from undergoing any displacement under any external force.

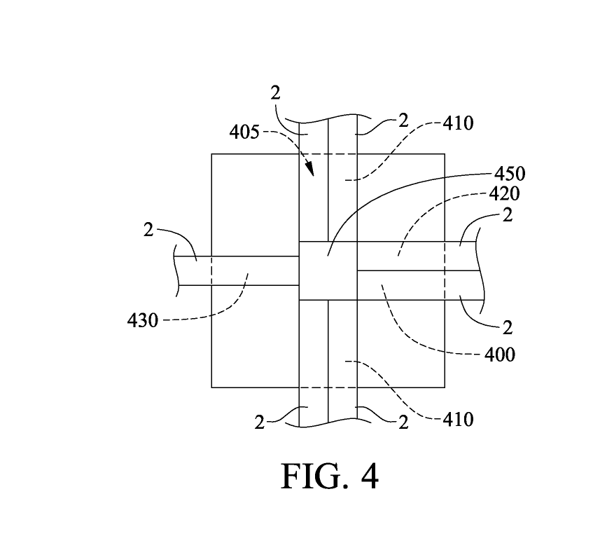

Referring to FIG. 4, there is shown a schematic view of how to fasten panels to the fourth side 400 of the panel fastener 1 according to the second embodiment of the present invention. The first notch 410 of the fourth side 400 is of a width sufficient to admit two superimposed panels 2. The third notch 430 of the fourth side 400 is of a width sufficient to admit one panel 2. The fourth notch 440 of the fourth side 400 is of a width sufficient to admit two superimposed panels 2. The panels 2 are pressed against the press bump 450 and thereby prevented from undergoing any displacement under any external force.

The first side 100, second side 200, third side 300 and fourth side 400 of the panel fastener 1 and the panels 2 are described above for illustrative sake, but they are subject to changes, depending on user needs or design requirements. When appropriately arranged, the panels 2 are fastened together by the panel fasteners 1 to build a DIY cabinet.

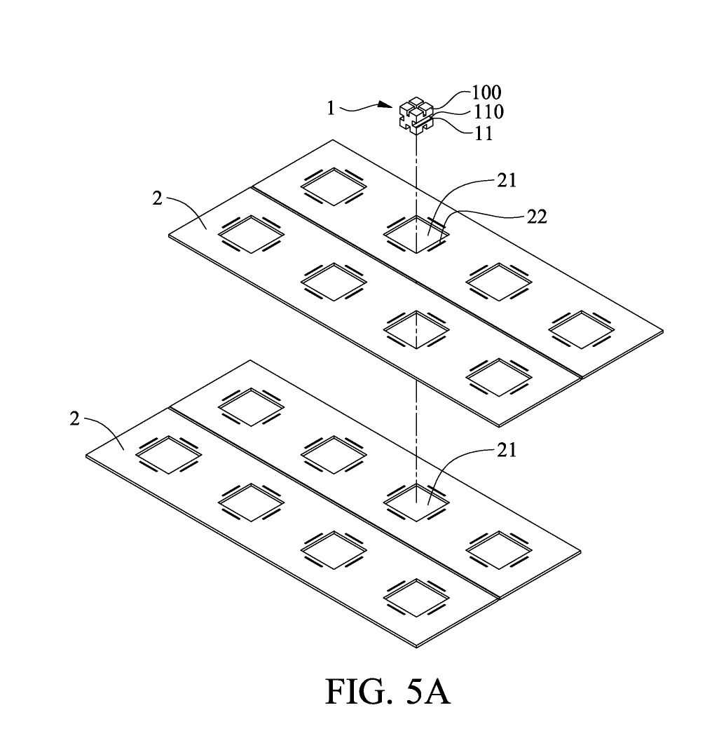

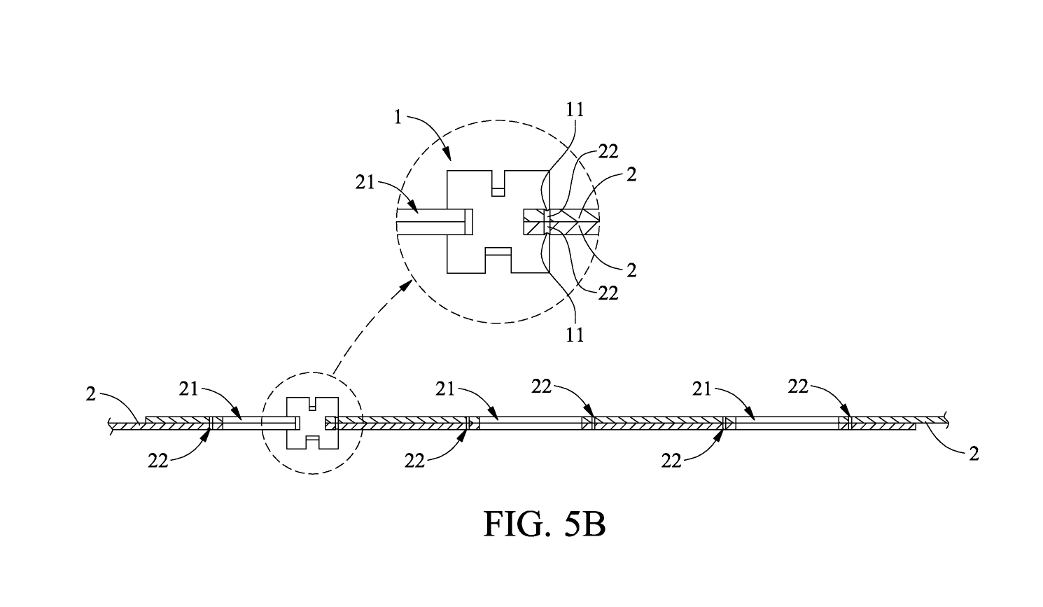

Referring to FIG. 5A and FIG. 5B, there are shown an exploded view and a schematic view of how to fasten the panels 2 to the panel fastener 1 according to the second embodiment of the present invention, respectively. In the second embodiment, the panels 2 each further comprise one or more joint holes 21. To superimpose the panels 2 in such a manner that the superimposed panels 2 are not flush with each other, it is necessary to align the joint holes 21 of the panels 2, engage the first notch 110 of the first side 100 of the panel fastener 1 with the joint holes 21 of the panels 2 to superimpose the panels 2, and further engage the engaging flange 11 of the first notch 110 of the first side 100 of the panel fastener 1 with the panels 2.

In this embodiment, the panels 2 each further comprise a plurality of engaging grooves 22 disposed around each joint hole 21. Hence, the panel fastener 1 can approach the two superimposed panels 2 from any direction to engage with the two superimposed panels 2. When the panel fastener 1 is engaged with the two superimposed panels 2, the engaging flange 11 of the panel fastener 1 is engaged with the engaging grooves 22 of the panels 2, thereby coupling the panels 2 together by the panel fastener 1.

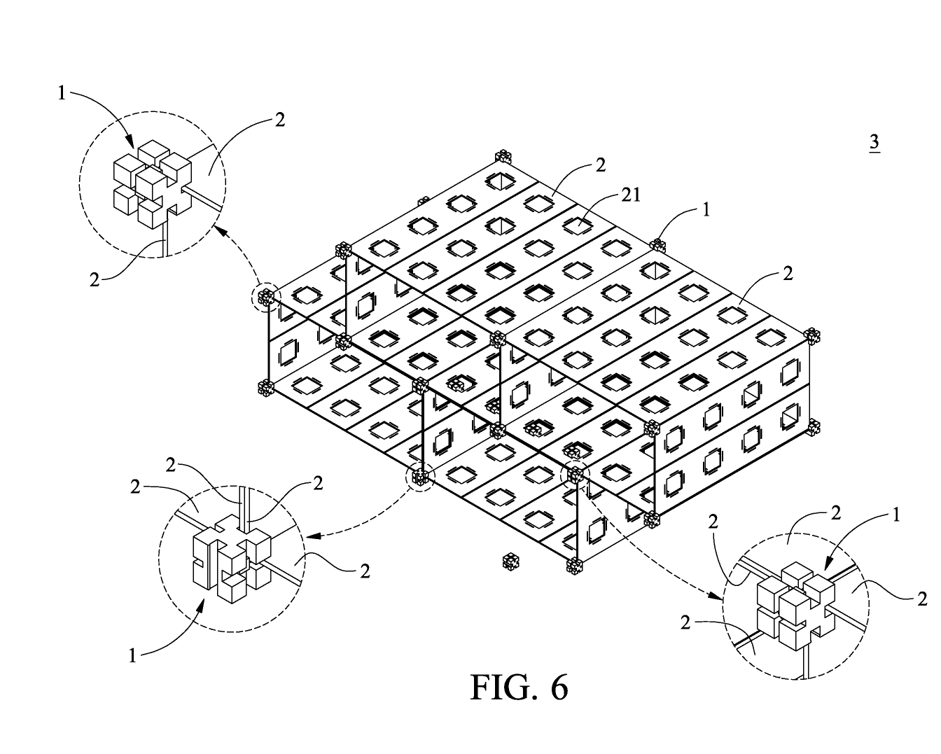

Referring to FIG. 6, there is shown a schematic view of a DIY cabinet 3 which consists of the panels 2 fastened to the panel fastener 1 according to the second embodiment of the present invention. As shown in the diagram, the panel fasteners 1 and the panels 2 are combined to build the DIY cabinet 3 which comes in various shapes as needed. For instance, the panel fasteners 1 approach the two superimposed panels 2 from any direction to engage with the two superimposed panels 2 in such a manner that the two superimposed panels 2 have an adjustable length, thereby allowing the DIY cabinet 3 to have a variable width. Referring to FIG. 6, the DIY cabinet 3 thus built is hollowed out and stepped. The quantity of the panel fasteners 1, the quantity of the panels 2 and the shape of the DIY cabinet 3 are subject to changes according to user needs or design requirements. By contrast, according to the prior art, conventional DIY cabinets have disadvantages as follows: a wide variety of panel fasteners is not universal; the DIY cabinets thus built are restricted to constant width and connection in parallel (conventional panels of the conventional DIY cabinets must be connected in parallel, thereby precluding the possibility that the conventional DIY cabinets can be hollowed out or stepped.)

In conclusion, the present invention provides a panel fastener whose outer sides have notches which come in various shapes so that panels can be put together in different ways by the panel fastener, thereby rendering it easy for a user to assemble a DIY cabinet.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A panel fastener for use with a plurality of panels to build a DIY cabinet, the panel fastener comprising:
a first side with a first notch;
a second side with a cruciform notch formed from a first notch and a second notch; and
a third side with a cruciform notch formed from a first notch and a second notch,
wherein the first notch of the first side is of a width sufficient to admit two panels, the first notch of the second side to admit one panel, the second notch of the second side to admit one panel, the first notch of the third side to admit two panels, and the second notch of the third side to admit one panel.

2. The panel fastener of claim 1, wherein a press bump is disposed at a junction of the first notch of the second side and the second notch of the second side, and a press bump is disposed at a junction of the first notch of the third side and the second notch of the third side.

3. The panel fastener of claim 2, further comprising a fourth side with a cruciform notch, the cruciform notch being formed from a first notch and a second notch, the first and second notches each being of a width sufficient to admit at least one panel.

4. The panel fastener of claim 3, wherein the second notch of the fourth side is formed from a third notch and a fourth notch, whereas the first notch of the fourth side is of a width sufficient to admit two panels, the third notch of the fourth side to admit one panel, and the fourth notch of the fourth side to admit two panels.

5. The panel fastener of claim 4, wherein a press bump is disposed at a junction of the first notch, the third notch and the fourth notch of the fourth side.

6. The panel fastener of claim 5, wherein an engaging flange is disposed at edges of the first, second, third and fourth notches.

7. The panel fastener of claim 6, wherein an engaging flange is disposed at two edges of the first notch of the first side.

8. A panel engaged with the panel fastener of claim 1 to build a DIY cabinet.

9. The panel of claim 8, further comprising at least a joint hole which the first notch of the first side of the panel fastener is unfastenably engaged with.

10. A panel engaged with the panel fastener of claim 6 to build a DIY cabinet.

11. The panel of claim 10, further comprising at least a joint hole which the first notch of the first side of the panel fastener is unfastenably engaged with.

12. The panel of claim 11, wherein an engaging groove is disposed at an edge of the at least a joint hole and engaged with the engaging flanges of the first, second, third and fourth notches.
